(19) United States
(12) Patent Application Publication
(10) Pub. No.: US 2006/0031251 A1
(43) Pub. Date: Feb. 9, 2006

(54) Apparatus, system, and method for directly addressing a legacy database system

(75) Inventors: Kenneth Ray Blackman, San Jose, CA (US); Haley Hoi Lee Fung, Alviso, CA (US); Gerald Dean Hughes, Morgan Hill, CA (US); Bill Thanh Huynh, Oakland, CA (US); Steve T. Kuo, San Jose, CA (US); Jack Chiu-Chiu Yuan, San Jose, CA (US)

Correspondence Address: KUNZLER & ASSOCIATES, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 10/912,303

(22) Filed: Aug. 5, 2004

(51) Int. Cl. G06F 17/00

(52) U.S. Cl. 707/103 Y

(57) ABSTRACT

An apparatus, system, and method are disclosed for directly accessing a database management system (“DBMS”). A client communication module is included to transmit a data call between a client and a client interface wherein the client interface resides within a database network. A DBMS communication module is included to transmit the data call between the client interface and a hierarchical DBMS on a host within the database network. The client interface and hierarchical DBMS are free of user-defined code.

### BACKGROUND OF THE INVENTION

1. Field of the Invention

This invention relates to legacy database access and more particularly relates to accessing data in a legacy database management system without a user-defined translator residing on a system image of a host and through a client interface that may reside anywhere in a database network containing the database management system.

2. Description of the Related Art

International Business Machine's (“IBM”) Information Management System (“IMS”) is a widely used legacy database that has been in use for decades. The IMS is a hierarchical Database Management System (“DBMS”). Accessing data from an IMS on a host has changed in recent years. In the past, clients accessed data from a basic input/output (“I/O”) terminal also referred to as a “dumb terminal.” This required user-defined code running on a host containing the IMS.

More recently, users may use computers and computer systems distributed across a network and connected to a host to access data on an IMS. Instead of data being processed on the host, users may desire to simply retrieve the data from the host and process the data on a server within the network.

A user application within the network may be written in a variety of computer languages. Users desire direct IMS data access through a variety of data formats such as Structured Query Language (“SQL”), Extendible Markup Language (“XML”), and Java Database Connectivity (“JDBC”).

To facilitate access of IMS data from a distributed computer system using protocols other than the IMS specific Data Language/1 (“DL/I”), IBM developed an Open Database Access (“ODBA”) interface. FIG. 1 is an illustration of a currently available system 100 for client access of data that includes an IMS along with an ODBA.

The system 100 includes a client 102 in communication with a user-defined translator 104 that resides in a host 106. The client 102 is located external to the host 106 and communicates typically via Transmission Control Protocol/Internet Protocol (“TCP/IP”), however, other similar protocols may be used. The user-defined translator 104 communicates with the ODBA, which serves as a database interface 108 and communicates with a hierarchical DBMS 110 (herein referred to as simply DBMS, and in this case is more specifically the IMS). Each DBMS 110 communicates with one ODBA 108. The DBMS 110 communicates with data storage devices 112.

The database interface (ODBA) 108 requires a user to write a user-defined translator 104 to translate data calls from the client application to a format required by the database interface (ODBA) 108 called AERTDLI. A data call is differentiated from a transaction manager (“TM”) call in that a data call is limited to writing and retrieving data directly from a database. A TM call relates to a transaction with IMS.

In addition, the user-defined translator 104 must reside on the same host 106 system image or logical partition (“LPAR”) of the host 106 as the DBMS 110 being accessed because communication between the user-defined translator 104 and the database interface (ODBA) 108 is limited to program calls (“PC”). A PC is a type of inter-process communication that must be initiated and terminated within the host 106. The database interface (ODBA) 108 then converts the AERTDLI calls to DL/I requests suitable for the DBMS 110. The DL/I request are sent using PC protocol.

While the use of the database interface (ODBA) 108 allows users to access data from an external client 102, the ODBA 108 also requires users to write a user-defined translator 104 for each database interface (ODBA) 108, which is burdensome for users. In addition, a different user-defined translator 104 is required for each connection between a client 102 and a database interface (ODBA) 108 residing on a separate system image or logical partition (“LPAR”) of a host 106. Because of the burden of writing, migrating, and maintaining a user-defined translator 104 program, users have typically written single-threaded user-defined translators 104 accessible by one client 102 at a time.

Clients 102 accessing multiple DBMSs 110 (and each corresponding database interface (ODBA) 108) on different hosts 106 within a database network or sysplex requires that a separate user-defined translator 104 be written for each database interface (ODBA) 108. A database network or sysplex is a group of hosts that may communicate with each other to share access to duplicate or different databases associated with each individual host. The hosts may be physically adjacent to each other or separated by some distance. A database network may also include communication between separate LPARs on a single host. The communication between hosts or LPARs is not, by definition, a PC but is typically some other protocol. One such protocol for communication between hosts or LPARs is IBM's cross-coupling facility (“XCF”) calls. These calls use a cross-coupling facility which links a plurality of hosts 106 within a database network. Accessing each DBMS 110 requires the client 102 to have access to each host 106 where a DBMS 110 resides.

Another option for accessing the database interface (ODBA) 108 is through the use of a JDBC call for data calls. The use of a JDBC call does not require a user-defined translator 104 on the host 106. Instead, the JDBC call passes through a connector for Java (not shown).

Unfortunately, using a JDBC call for a data call has limitations and creates other problems. One limitation is that a JDBC call must include the exact pathway to the database interface (ODBA) 108. Knowledge of the pathway may be difficult for a user to obtain. The pathway should include the host name and file system path to the ODBA 108 being accessed. In addition, if a JDBC call is sent through an application server to an IMS or ODBA 108 and the application server terminates before the completion of the call, the entire IMS crashes causing time delays in bringing the IMS back online.

From the foregoing discussion, it should be apparent that a need exists for an apparatus, system, and method for a client to directly access a DBMS 110. Beneficially, such an apparatus, system, and method to directly access a DBMS 110 would allow access without a user-defined translator 104 on the host 106 where the DBMS 110 resides. The apparatus, system and method would allow client 102 access to multiple DBMSs 110 from a single data call and would allow a data call to be routed through a plurality of paths from the client 102 to the DBMS 110. The apparatus, system and method would not require a user to know an exact pathway to a database interface 108 and would not cause the DBMS 110 to crash if the application server terminates before the completion of the call had been processed by DBMS 110.

### SUMMARY OF THE INVENTION

The present embodiment has been developed in response to the present state of the art, and in particular, in response to the problems and needs in the art that have not yet been fully solved by currently available methods of accessing data in a legacy database. Accordingly, the present embodiment has been developed to provide an apparatus, system, and method for direct access to a legacy database or hierarchical DBMS that overcome many or all of the above-discussed shortcomings in the art.

The apparatus for directly accessing a DBMS is provided with a logic unit containing a plurality of modules configured to functionally execute the necessary steps of transmitting a data call from a client to a DBMS on a host within a database network without a user-defined translator on the host. These modules in the described embodiments include a client communication module that transmits a data call between a client and a client interface where the client interface resides within a database network, and a DBMS communication module that transmits the data call between the client interface and a hierarchical DBMS on a host within the database network.

In one embodiment, the client interface resides on a host system image that is different from a host system image where the DBMS resides. In another embodiment, the client interface is configured to communicate data calls with a plurality of DBMSs. In yet another embodiment, the client interface is free of user-defined code.

The DBMS is further configured, in one embodiment, to communicate data calls with a plurality of client interfaces. In another embodiment, the DBMS is an Information Management System (“IMS”) software program. In a further embodiment, client interface is an IMS Connect software program.

The DBMS communication module, in one embodiment, is further configured to transmit the data call to a second DBMS in response to a first DBMS being unavailable. In an alternate embodiment, the client communication module is further configured to redirect a data call to a second DBMS in response to a first DBMS being unavailable. In another embodiment, the client communication module is further configured to transmit the data call to a second client interface in response to a first client interface being unavailable.

A method of the present embodiment is also presented for directly accessing a DBMS. The method in the disclosed embodiments substantially includes the steps necessary to carry out the functions presented above with respect to the operation of the described apparatus. In one embodiment, the method includes transmitting a data call between a client and a client interface where the client interface resides within a database network and transmitting the data call between the client interface and a hierarchical DBMS on a host within the database network.

In a further embodiment, the client interface resides on a host system image that is different from a host system image where the DBMS resides. In another embodiment, the client interface is configured to communicate data calls with a plurality of DBMSs. In a preferred embodiment, the client interface is free from user-defined code and is an IMS Connect.

The DBMS, in one embodiment, is configured to communicate data calls with a plurality of client interfaces. In another embodiment, the DBMS is an Information Management System (“IMS”) software program.

The method may further include transmitting the data call to a second DBMS in response to a first DBMS being unavailable. In a further embodiment, the method further includes transmitting the data call to a second client interface in response to a first client interface being unavailable.

Reference throughout this specification to features, advantages, or similar language does not imply that all of the features and advantages that may be realized with the present embodiment should be or are in any single embodiment of the invention. Rather, language referring to the features and advantages is understood to mean that a specific feature, advantage, or characteristic described in connection with an embodiment is included in at least one version of the present embodiment. Thus, discussion of the features and advantages, and similar language, throughout this specification may, but do not necessarily, refer to the same embodiment.

The present embodiment also includes embodiments arranged as a system and set of machine-readable instructions that comprise substantially the same functionality as the components and steps described above in relation to the apparatus and method. The features and advantages of different embodiments will become more fully apparent from the following description and appended claims, or may be learned by the practice of embodiments of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a currently available system for a user to access data in a DBMS on a host from a client.

FIG. 2 is a schematic block diagram illustrating one embodiment of an apparatus for directly accessing a DBMS;

FIG. 3 is a schematic block diagram illustrating one embodiment of a system for directly accessing a DBMS;

FIG. 4 is a schematic block diagram illustrating an alternate embodiment of a system with multiple hosts for directly accessing a DBMS;

FIG. 5 is a schematic flow chart diagram illustrating one embodiment of a method for directly accessing a DBMS; and

FIG. 6 is a schematic flow chart diagram illustrating another co embodiment of a method for directly accessing a DBMS.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one version of the present embodiment. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

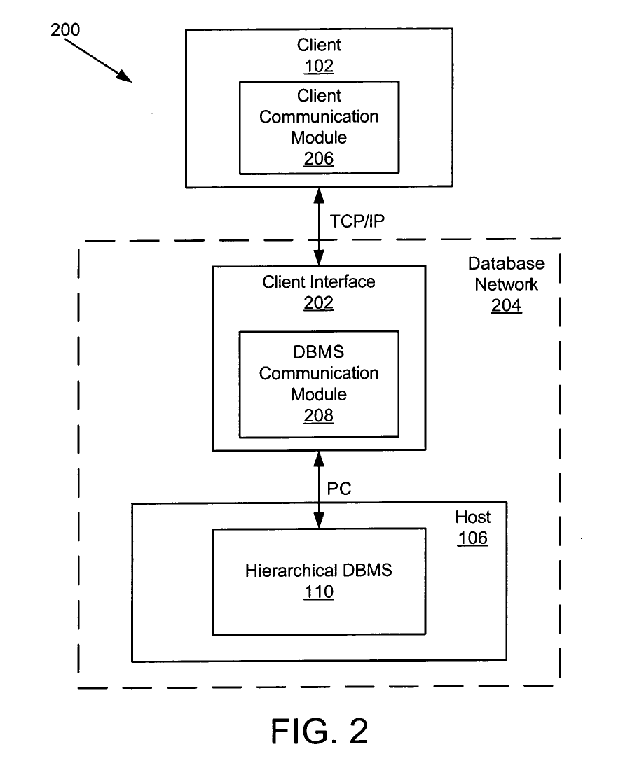

FIG. 2 is a schematic block diagram illustrating one embodiment of an apparatus 200 for directly accessing a DBMS 110. The apparatus 200 includes a client 102 in communication with a client interface 202. The client interface 202 communicates with a hierarchical DBMS (or simply DBMS) 110. The client interface 202 resides within a database network 204 and the DBMS 110 resides on a host 106 connected to the database network 204. In a preferred embodiment, the client interface 202 does not include user-defined code or a user-defined translator 104.

The client interface 202 serves to relay a variety of messages between clients 102 and hosts 106. In particular, the client interface 202 may send and receive data calls from a client 102, converts the data calls to a format suitable for the DBMS 110, and communicate the formatted data calls with one or more DBMS 110. Preferably, the client interface 202 is configured to communicate with a client 102 via TCP/IP, which is a commercially accepted, non-proprietary protocol allowing client applications in many formats to communicate with the client interface 202. Alternatively, the client interface 202 is configured to communicate with a client 102 using a PC or other suitable protocol when the client 102 resides on the same host 106 or host system image as the client interface 202. The client interface 202 may also accept TM calls and communicate the TM calls to a transaction manager portion of the DBMS 110.

The client interface 202 may reside on the host 106, within a system image or LPAR of the host 106, or on another host within the database network 204. In one embodiment, the client interface 202 is an IMS Connect software program. Typically the client interface 202 communicates with the client 102 via TCP/IP, but may communicate via other commercially available transmission protocols. In another embodiment, the client 102 is a user application on the same host as the client interface 202 and may communicate via a PC. In one embodiment, a plurality of clients 102 may communicate with a client interface 202.

In one embodiment, the client interface 202 communicates with the DBMS 110 using a PC when the client interface 202 is located on the same host system image or LPAR. In another embodiment, the client interface 202 communicates with the DBMS 110 using an XCF call when the client interface 202 is on a different host image than the host image of the DBMS 110.

In one example, the client interface 202 may communicate with a plurality of DBMSs 110. In another example, a single DBMS 110 may communicate with a plurality of client interfaces 202. Advantageously, the client 102 can access a plurality of DBMSs 110 through a plurality of client interfaces 202. This capability is not available in current legacy DBMS access schemes.

In the apparatus 200, the client 102 includes a client communication module 206 configured to transmit a data call between the client 102 and the client interface 202 and vice-versa. Alternatively, the client communication module 206 may be located in the client interface 202, on the host 106, or in another system on the database network 204. The client communication module 206 may also be divided and distributed across the client 102 and other elements within the database network 204.

Additionally, a DBMS communication module 208 is included in the client interface 202 and is configured to transmit the data call between the client interface 202 and the DBMS 110 and vice-versa. In other embodiments, the DBMS communication module 208 may be located in the client 102, the host 106, or another system on the database network 204. One skilled in the art will recognize other suitable locations for the client communication module 206 and the DBMS communication module 208. The DBMS communication module 208 may also be divided and distributed across the client 102 and other elements within the database network 204.

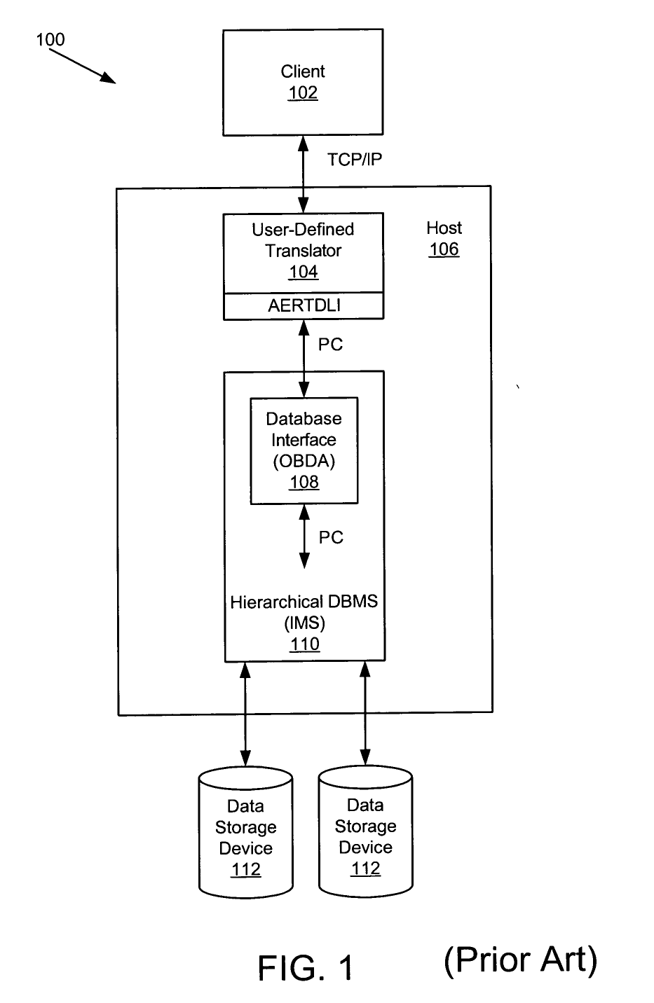

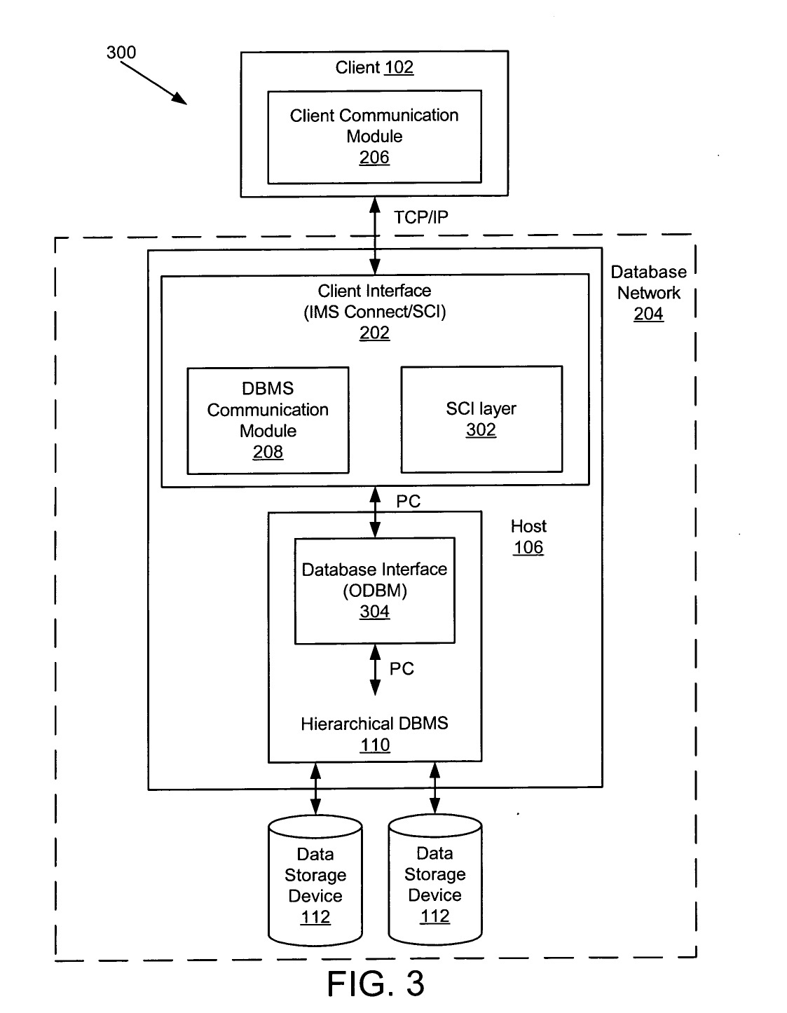

FIG. 3 is a schematic block diagram illustrating one embodiment of a system 300 for directly accessing a DBMS. The system 300 includes a client 102 with a client communication module 206, a client interface 202 with a DBMS communication module 208 in a database network 204, and a hierarchical DBMS 110 within a host 106 as described above in relation to FIGS. 1 and 2. In system 300, however, the client interface 202 is located within the host 106. The DBMS 110 may also communicate with one or more data storage devices 112.

In one embodiment, the client interface 202 is an IMS Connect software program with a Structure Call Interface (“SCI”) layer 302. The IMS Connect communicates data calls to the SCI layer 302. The SCI 302 then transmits the data call to the DBMS 110 via a PC because, in this example, the client interface 202 and the DBMS 110 are on the same host 106.

In a preferred embodiment, the IMS Connect also transmits transaction manager (“TM”) calls and transmits the TM calls to an Open Transaction Manager Access (“OTMA”) module (not shown) which then transmits the TM calls to a DBMS 110. In another preferred embodiment, the SCI layer 302 also communicates with an operations manager (“OM”).

In one embodiment, the DBMS 110 includes a database interface or Open Database Manager (“ODBM”) 304 that is an interface between the SCI layer 302 and the DBMS 110. The ODBM 304 takes the place of the ODBA 108 shown in FIG. 1. In one embodiment, the database interface (ODBM) 304 is also multitasking allowing multiple clients to access to the DBMS 110 simultaneously. The currently available data interface (ODBA) 108 is not multitasking.

In one embodiment, data calls from the client interface (IMS Connect) 202 to the database interface (ODBM) 304 are in the IBM proprietary AERTDLI format. Other embodiments with other database applications may use another proprietary or non-proprietary format for data calls between a client interface 202 and a database interface 304.

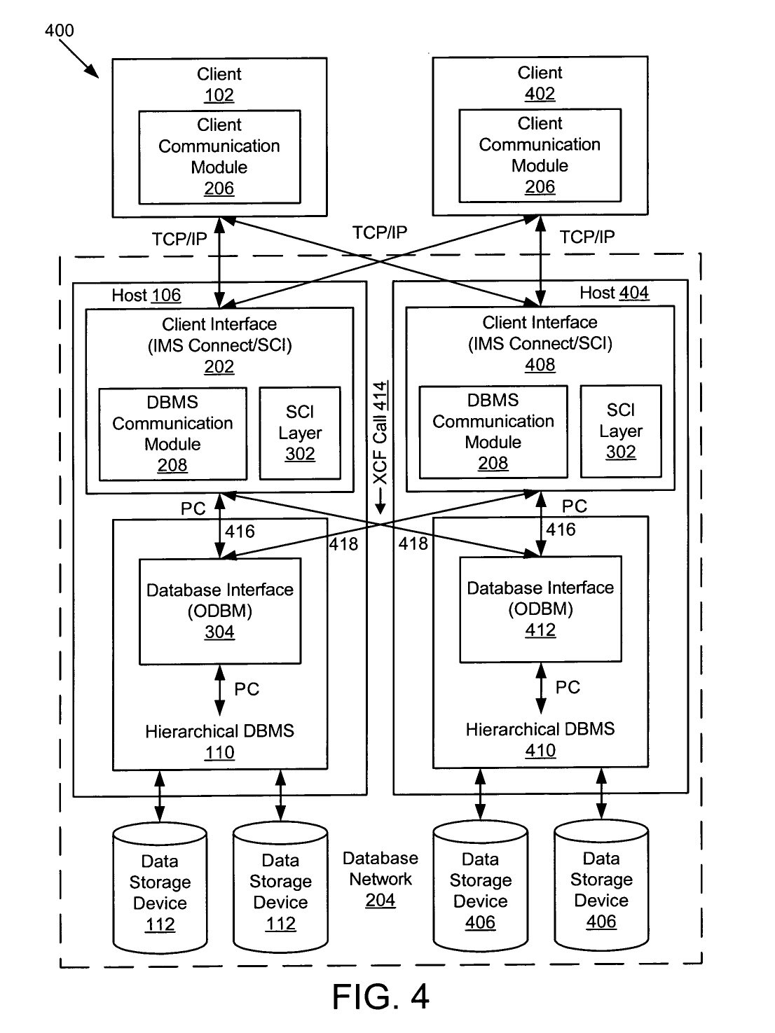

The SCI layer 302 exchanges data calls with the database interface (ODBM) 304. The ODBM 304 then converts the data call to the DL/I format and sends the data call to the DBMS 110. An ODBM 304 is configured to communicate with one or more client interfaces (IMS Connect/SCI) 202 residing on the host 106 or within the database network 204 as described below in relation to FIG. 4.

In another embodiment, the ODBM 304 is registered to participate in a database network 204 system for a two-phase commit process. A two-phase commit process seeks to ensure that a transaction or data call affecting more than one element of one or more databases completes the transaction or data call before making the transaction or data call permanent. In one embodiment, the two-phase commit process is implemented using a Recoverable Resource System (“RRS”) associated with the z/OS operating system.

FIG. 4 is a schematic block diagram illustrating an alternate embodiment of a system 400 with multiple hosts for directly accessing a DBMS. As described in relation to the system 300 illustrated in FIG. 3, the system 400 includes a client 102 with a client communication module 206 and a database network 204 including a host 106 and one or more data storage devices 112. The host 106 includes a client interface 202 with a DBMS communication module 208 and an SCI layer 302 and a DBMS 110 with a database interface (ODBM) 304.

The system 400, however, includes an additional client 402 with a client communication module 206, and included within the database network 204 is an additional host 404 and data storage devices 406. The additional host 404 includes a client interface 408 with a DBMS communication module 208 and an SCI layer 302 and a DBMS 410 with a database interface (ODBM) 412.

As illustrated, in one embodiment because the IMS Connect 202, 408 may communicate with a plurality of clients 102, 402, the first client 102 may communicate with the first client interface 202 or the second client interface 408 and the second client 402 may communicate with the first client interface 202 or the second client interface 408. The ability for a client interface 202, 408 to communicate with a plurality of clients 102, 402, is not used in currently available client interfaces 202 because user-defined translators 104 typically do not provide multitasking. As discussed above, communication between clients 102, 402 and client interfaces 202, 408 is typically TCP/IP, but may use another transmission protocol.

In another embodiment, the first client interface 202 may communicate with the first DBMS 110 or the second DBMS 410 and the second client interface 408 may communicate with the first DBMS 110 or the second DBMS 410. As described above in relation to FIG. 3, communications between a client interface 202, 408 and a DBMS 110, 410 within the same host 106, 404 is typically a program call. Communications between a client interface 202, 408 and a DBMS 110, 410 not residing on the same host 106, 404 typically uses an XCF call 414. Each client interface 202, 408 communicates with each DBMS 110, 410 via a database interface 304, 412.

Preferably, the client interface 202, 408 comprises an IMS Connect and an SCI layer 302. The SCI layer 302 may communicate with a data interface (ODBM) 304 that is part of a DBMS 110, 410 either using a PC call 416 or an XCF call 414 where the PC call 416 is used for inter-host communications and the XCF call 414 is used for intra-host communications 418. The addition of intra-host communication 418 in certain embodiments allows a user to route a data call to a second DBMS 410 in response to a notification that a first DBMS 110 is unavailable. Typically, a table is used by the client interface (IMS Connect) 202 indicating the status and availability of connected DBMSs 110, 410 and associated database interfaces (ODBM) 304, 412. The client interface (IMS Connect) 202 passes the status and availability information from the table to the Client 102, 402 via a notification. Rerouting of a data call from a user through a client 102, 402 outside a database network 204 is free from any user-defined code on the database network 204.

One advantage of the system 400 is that a data call from a first client 102 may be routed through a second client interface 408 to a first DBMS 110 if a first client interface 202 is unavailable. A client interface 202, 408 may be unavailable due to high workload or technical problems. In addition, a client may reach any number of DBMSs 110, 410 through one or more client interfaces 202, 408. Likewise, a DBMS 110, 410 may be reached from any number of client interfaces 202, 408.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

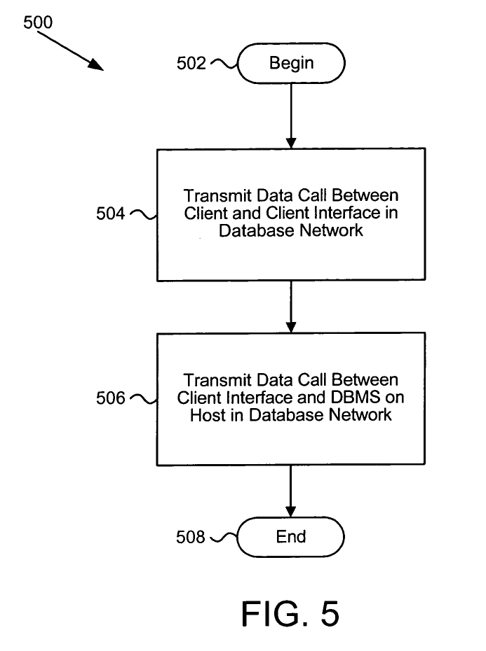

FIG. 5 is a schematic flow chart diagram illustrating one embodiment of a method 500 for directly accessing a DBMS. The method 500 begins 502 and the client communication module 206 transmits 504 a data call between the client 102 and the client interface 202 where the client interface 202 resides in a database network 204. The DBMS communication module 208 transmits 506 a data call between the client interface 202 and the DBMS 110 which resides on the host 106 within the database network 204, and the method 500 ends 508. The client interface 202 may reside on the host 106 or on another host in the database network 204. In addition, the client interface 202 may be on a host system image in the database network 204 different from the host system image of the DBMS 110.

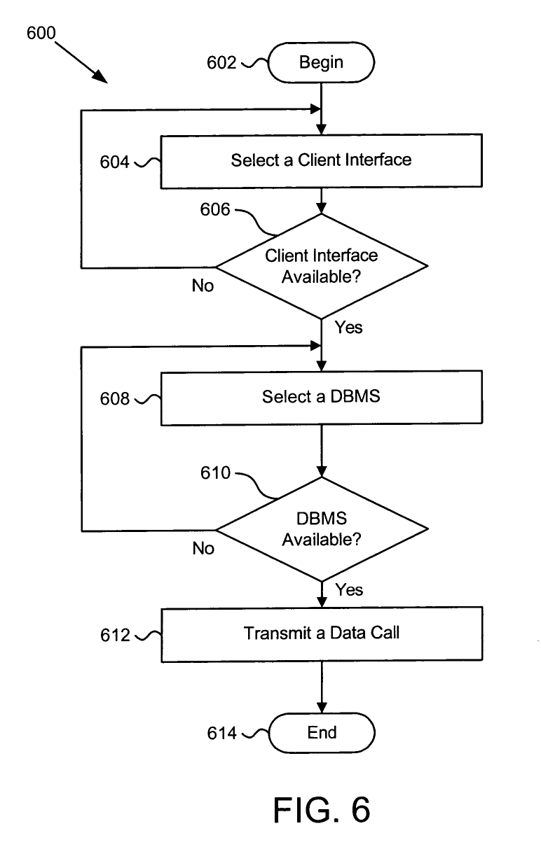

FIG. 6 is a schematic flow chart diagram illustrating another embodiment of a method 600 for directly accessing a DBMS. The method 600 begins 602 when a client 102 selects 604 a client interface 202. A client 102 may select 604 a client interface 202 when a user application on the client 102 sends a data call to a specific client interface 202 that has access to a database where some desired data resides. If the selected client interface 202 is not available 606, the client 102 selects 604 another client interface 202. In one embodiment, if a client interface 202 is selected 604 but is unavailable, the client interface 202 transmits a notification to the client 102 indicating available client interfaces 202 and each client interface 202 status. The client interface 202 typically references a table that includes status and availability information of DBMSs 110 and other client interfaces 202. The client interface can use the information in the table to notify a client 102 of the status of a DBMS 110 and a client interface 202. The client 102 may then review the notification and select another client interface 202.

When an available client interface 202 is selected 606, the client 202 selects 608 a DBMS 110. A client 202 may select 608 a DBMS 110 when a user application on a client 102 seeks data from a database accessible from the selected DBMS 110. If the selected DBMS 110 is unavailable 610, the client 102 selects 608 another DBMS 110. The second DBMS 110 may have access to a data store redundant to the originally selected DBMS 110. When an available DBMS 110 is selected 610, the Client Communication Module 206 transmits 612 a data call to the selected available client interface 202 and the DBMS communication module 208 transmits 612 the data call from the client interface 202 to the selected available DBMS 110 and the method 600 ends 614. Based on whether the DBMS 110 is on the same host 110, the Client Communication Module 206 may send a PC call 416 or an XCF call 418.

In one embodiment, if a DBMS 110 is selected 608 and is unavailable, the client interface 202 transmits a notification to the client 102 indicating available DBMSs 110 and the status of each available DBMS 110. The method 600 beneficially does not cause a DBMS 110 to crash if a database interface 108 is selected and the associated DBMS 110 is not reachable because of an application server error or timeout, as is the case with a JDBC call described above, because the client interface 202 and database interface 304 are configured to successfully handle data calls to an unavailable DBMS 110 or database interface 304 without causing the DBMS 110 to crash.

The present embodiment may be in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for directly accessing a database management system (“DBMS”), the apparatus comprising:
a client communication module configured to transmit a data call between a client and a client interface, wherein the client interface resides within a database network; and
a DBMS communication module configured to transmit the data call between the client interface and a hierarchical DBMS on a host within the database network.

2. The apparatus of claim 1, wherein the client interface resides on a host system image that is different from a host system image where the DBMS resides.

3. The apparatus of claim 1, wherein the client interface is configured to communicate data calls with a plurality of DBMSs.

4. The apparatus of claim 1, wherein the client interface is free from user-defined code.

5. The apparatus of claim 1, wherein the DBMS is configured to communicate data calls with a plurality of client interfaces.

6. The apparatus of claim 1, wherein the DBMS is an Information Management System (“IMS”) software program.

7. The apparatus of claim 1, wherein the client interface is an IMS Connect software program.

8. The apparatus of claim 1, wherein the DBMS communication module is further configured to transmit the data call to a second DBMS in response to a first DBMS being unavailable.

9. The apparatus of claim 1, wherein the client communication module is further configured to redirect a data call to a second DBMS in response to a first DBMS being unavailable.

10. The apparatus of claim 1, wherein the client communication module is further configured to transmit the data call to a second client interface in response to a first client interface being unavailable.

11. A system to for directly accessing a DBMS, the system comprising:
a client configured to transmit data calls in a native language;
a client communication module configured to transmit a data call between the client and a client interface, wherein the client interface resides within a database network; and
a DBMS communication module configured to transmit the data call between the client interface and a hierarchical DBMS on a host within the database network.

12. The system of claim 11, wherein the client interface resides on a host system image that is different from a host system image where the DBMS resides.

13. The system of claim 11, wherein the client interface is configured to communicate data calls with a plurality of DBMSs.

14. The system of claim 11, wherein the client interface is free from user-defined code.

15. The system of claim 11, wherein the DBMS is configured to communicate data calls with a plurality of client interfaces.

16. The system of claim 11, wherein the DBMS is an Information Management System (“IMS”) software program.

17. The system of claim 11, wherein the client interface is an IMS Connect software program.

18. The system of claim 11, wherein the DBMS communication module is further configured to transmit the data call to a second DBMS in response to a first DBMS being unavailable.

19. The system of claim 11, wherein the client communication module is further configured to redirect a data call to a second DBMS in response to a first DBMS being unavailable.

20. The system of claim 11, wherein the client communication module is further configured to transmit the data call to a second client interface in response to a first client interface being unavailable.

21. A signal bearing medium tangibly embodying a program of machine-readable instructions executable by a digital processing apparatus to perform operations for directly accessing a DBMS, the operations comprising:
transmitting a data call between a client and a client interface, wherein the client interface resides within a database network; and
transmitting the data call between the client interface and a hierarchical DBMS on a host within the database network.

22. The signal bearing medium of claim 21, wherein the client interface resides on a host system image that is different from a host system image where the DBMS resides.

23. The signal bearing medium of claim 21, wherein the client interface is configured to communicate data calls with a plurality of DBMSs.

24. The signal bearing medium of claim 21, wherein the client interface is free from user-defined code.

25. The signal bearing medium of claim 21, wherein the DBMS is configured to communicate data calls with a plurality of client interfaces.

26. The signal bearing medium of claim 21, wherein the DBMS is an Information Management System (“IMS”) software program.

27. The signal bearing medium of claim 21, wherein the client interface is an IMS Connect software program.

28. The signal bearing medium of claim 21, further comprising an operation to transmit the data call to a second DBMS in response to a first DBMS being unavailable.

29. The signal bearing medium of claim 21, further comprising an operation to transmit the data call to a second client interface in response to a first client interface being unavailable.
